(19) United States
(12) Patent Application Publication
(10) Pub. No.: US 2018/0093890 A1
(43) Pub. Date: Apr. 5, 2018

(54) AQUEOUS HYDROGEN FLUORIDE COMPOSITIONS

(71) Applicant: Honeywell International Inc., Morris Plains, NJ (US)

(72) Inventors: Matthew H. Luly, Hamburg, NY (US); Bernard E. Pointner, Buffalo, NY (US)

(21) Appl. No.: 15/718,743

(22) Filed: Sep. 28, 2017

Related U.S. Application Data
(60) Provisional application No. 62/403,991, filed on Oct. 4, 2016.

(51) Int. Cl. C01B 7/19; B01J 20/26; B01J 20/34; C08K 3/16

(52) U.S. Cl. CPC C01B 7/197; C08K 3/16; B01J 20/3425; B01J 20/267

(57) ABSTRACT

A composition is provided including aqueous hydrogen fluoride; and a cross-linked copolymer comprising acrylamide units cross-linked with an acrylic acid salt. The cross-linked polymer has an average liquid aqueous hydrogen fluoride absorption capacity of less than 40 grams aqueous hydrogen fluoride per gram of cross-linked polymer.

### CROSS-REFERENCE TO RELATED APPLICATION

This application claims priority to U.S. Provisional Patent Application Ser. No. 62/403,991, entitled AQUEOUS HYDROGEN FLUORIDE COMPOSITIONS, filed on Oct. 4, 2016, which is herein incorporated by reference in its entirety.

### FIELD

The present disclosure relates to hydrogen fluoride compositions, and more particularly to compositions of aqueous hydrogen fluoride and a polymer.

### BACKGROUND

Hydrogen fluoride is a well-known compound that is used in industry in a variety of processes including in alkylation reactions as a catalyst, in fluorination reactions as a fluorinating agent, in the manufacture of fluorides, in the separation of uranium isotopes, in the production of fluorine containing plastics, and in etching and cleaning applications. It is well known that hydrogen fluoride is a volatile, extremely hazardous substance the high vapor pressure of which renders it readily aerosolizable.

In an attempt to diminish the hazards of hydrogen fluoride, it has been combined with a variety of substances. U.S. Pat. No. 1,470,772 discloses a glass etching paste of mucilage, sulfuric add, and ammonium fluoride in which the hydrogen fluoride is formed in situ. U.S. Pat. No. 3,635,836 discloses dispersions of hydrogen fluoride, particulate proteinaceous material and a small amount of carboxyl substituted vinyl polymers useful as pickling agents, plumbing cleaners and paint removers. U.S. Pat. No. 4,383,868 discloses a method of treating anhydrous hydrogen fluoride spills by applying a particulate mixture of polyacrylamide and a polyalkyl(alk)acrylate to the surface of the spill. However, none of these compositions provides an intimate mixture of hydrogen fluoride and a substance that both reduces the hazards of hydrogen fluoride and, at the same time, permits the ready recovery of the hydrogen fluoride from the composition.

To overcome these problems, it has been suggested to provide a mixture of hydrogen fluoride and water-soluble polymer. For example, U.S. Pat. No. 6,177,058 describes gelatinous mixtures of hydrogen fluoride (HF) and sodium polyacrylate or polyacrylamide. U.S. Pat. Nos. 7,914,761 and 8,153,096 describe mixtures of anhydrous hydrogen fluoride and a polyacrylate-polyacrylamide cross-linked polymer. Example 21 of U.S. Pat. Nos. 7,914,761 and 8,153,096, which attempts to show the absorption of aqueous HF with an acrylamide/potassium acrylate cross-linked copolymer, states that 78.8 grams of aqueous HF (49 wt. %) were used, and an absorption ratio of 72.5 grams of aqueous HF per gram of polymer was determined.

Improvements in the foregoing processes and compositions are desired.

### SUMMARY

The present disclosure provides compositions of aqueous hydrogen fluoride and a polyacrylate-polyacrylamide cross-linked polymer.

A composition including aqueous hydrogen fluoride and a cross-linked copolymer is provided. The composition includes aqueous hydrogen fluoride and a cross-linked copolymer. The cross-linked copolymer includes acrylamide units cross-linked with an acrylic acid salt. The cross-linked polymer has an average liquid aqueous hydrogen fluoride absorption capacity of less than 40 grams aqueous hydrogen fluoride per gram of cross-linked polymer.

In one more particular embodiment, the aqueous hydrogen fluoride includes from 0.15 wt. % to 99.9 wt. % hydrogen fluoride, or even more particularly from 1 wt. % to 30 wt. % hydrogen fluoride, based on the total weight of hydrogen fluoride and water in the aqueous hydrogen fluoride.

In one more particular embodiment of any of the above embodiments, the acrylamide units are polyacrylamide units. In another more particular embodiment of any of the above embodiments, the acrylate acid salt is selected from the group consisting of potassium acrylate, sodium acrylate, and ammonium acrylate, or even more particularly, the acrylate acid salt is potassium acrylate. In one more particular embodiment of any of the above embodiments, the cross-linked polymer is a cross-linked acrylamide/potassium acrylate copolymer. In one more particular embodiment of any of the above embodiments, the copolymer has a weight average molecular weight of about 5,000 to about 5,000,000 Daltons.

In one more particular embodiment of any of the above embodiments, the cross-linked polymer is saturated with the aqueous hydrogen fluoride, wherein the cross-linked polymer comprises at least 2.5 wt. % of the composition.

In one more particular embodiment of any of the above embodiments, the composition is in the form of a solid or a gel.

In one exemplary embodiment, a method of forming an aqueous hydrogen fluoride composition is provided. The method includes mixing aqueous hydrogen fluoride and a cross-linked copolymer. The cross-linked copolymer includes acrylamide units cross-linked with an acrylic acid salt. The cross-linked polymer has an average liquid aqueous hydrogen fluoride absorption capacity of less than 40 grams aqueous hydrogen fluoride per gram of cross-linked polymer. In a more particular embodiment, the composition is in the form of a solid or a gel. In another more particular embodiment, the acrylamide units are polyacrylamide units and the acrylate acid salt is selected from the group consisting of potassium acrylate, sodium acrylate, and ammonium acrylate.

In one more particular embodiment of any of the above embodiments, the aqueous hydrogen fluoride includes from 0.06 wt. % to 99.9 wt. % hydrogen fluoride, or even more particularly from 1 wt. % to 30 wt. % hydrogen fluoride, based on the total weight of hydrogen fluoride and water in the aqueous hydrogen fluoride.

In one more particular embodiment of any of the above embodiments, the acrylamide units are polyacrylamide units and the acrylate acid salt is selected from the group consisting of potassium acrylate, sodium acrylate, and ammonium acrylate.

In one more particular embodiment of any of the above embodiments, the method also includes contacting the aqueous hydrogen fluoride composition with water, thereby recovering in the water at least a portion of hydrogen fluoride from the aqueous hydrogen fluoride composition. In an even more particular embodiment, the recovered hydrogen fluoride includes at least 80 wt. % of the hydrogen fluoride in the aqueous hydrogen fluoride composition.

In one exemplary embodiment, a method of recovering hydrogen fluoride, water, or a mixture of hydrogen fluoride and water from an aqueous hydrogen fluoride composition is provided. The method includes providing an aqueous hydrogen fluoride composition, the composition comprising aqueous hydrogen fluoride and a cross-linked copolymer. The cross-linked copolymer includes acrylamide units cross-linked with an acrylic acid salt and recovering at least a portion of the hydrogen fluoride, water, or a mixture of hydrogen fluoride and water by vaporizing the portion of the hydrogen fluoride, water, or a mixture of hydrogen fluoride and water from the aqueous hydrogen fluoride composition and condensing the vaporized hydrogen fluoride, water, or a mixture of hydrogen fluoride and water. The cross-linked polymer has an average liquid aqueous hydrogen fluoride absorption capacity of less than 40 grams aqueous hydrogen fluoride per gram of cross-linked polymer. In a more particular embodiment of any of the above embodiments, the acrylamide units are polyacrylamide units and the acrylate acid salt is selected from the group consisting of potassium acrylate, sodium acrylate, and ammonium acrylate. In another more particular embodiment, the composition is in the form of a solid or a gel. In a more particular embodiment, the method also includes pretreating the cross-linked copolymer with hydrogen fluoride by contacting the cross-linked copolymer with hydrogen fluoride to absorb at least a portion of the hydrogen fluoride with the cross-linked copolymer and recovering at least a portion of the absorbed hydrogen fluoride from the cross-linked copolymer; and contacting pretreated cross-linked copolymer with aqueous hydrogen fluoride to form the aqueous hydrogen fluoride composition. In another more particular embodiment of any of the above embodiments, the aqueous hydrogen fluoride comprises from 1 wt. % to 30 wt. % hydrogen fluoride, based on the total weight of hydrogen fluoride and water in the aqueous hydrogen fluoride.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 is related to the Examples and illustrates the log of the absorbent capacity as a function of HF concentration.

### DETAILED DESCRIPTION

The present disclosure is directed to compositions of aqueous hydrogen fluoride and a polyacrylate-polyacrylamide cross-linked polymer.

The present disclosure provides solid and semi-solid compositions comprising hydrogen fluoride compositions that facilitate the safe use, transport, and storage of hydrogen fluoride. Further, the chemical properties of the hydrogen fluoride in the compositions of the present disclosure are substantially unchanged from those of hydrogen fluoride in its pure state and, thus, hydrogen fluoride may be readily and quantitatively recovered from the compositions.

In certain embodiments of the disclosure, compositions including mixtures of aqueous hydrogen fluoride and a polyacrylate/polyacrylamide crossed-linked copolymer are provided. In some embodiments, the mixtures are solid or semi-solid, such as gelatinous.

As used herein, “aqueous hydrogen fluoride” means a mixture of water and hydrogen fluoride. Aqueous hydrogen fluoride is contrasted with pure water and pure hydrogen fluoride, also referred to as anhydrous hydrogen fluoride.

As used herein, “anhydrous hydrogen fluoride” means a substantially pure composition of hydrogen fluoride.

As used herein, the term “copolymer” means a polymer having two or more different monomer residues that have been polymerized and constructed as one or more chains. The arrangements of these monomer units in the chain include those that regularly alternate the different monomers or those that repeat monomer units in regular or random sequences. In addition, the chain can be straight, branched, or grafted, or can exist as a block copolymer.

As used herein, the term “cross-linked” means the attachment of two chains of polymer molecules by bridges composed of an element, a functional group, a compound, or a polymer unit, which join certain atoms of the chains by primary chemical bonds. In certain embodiments, cross-linking occurs between two or more polymer chains to form a copolymer structure. In certain other embodiments, cross-linking occurs between two or more copolymer chains that are similar in arrangement, such as between amide groups and carboxylic groups of the copolymer.

In some exemplary embodiments, the cross-linked copolymer of the present disclosure in its dry form is solid, such as in the form of a powder, granules, pellets, fiber, fabrics, mats, and pads and the like. When exposed to hydrogen fluoride, the copolymer chains expand or unfold and uptake or absorb hydrogen fluoride to form a solid or a semi-solid material, such as a gel. Due to the cross-linking of the copolymer, the copolymer is insoluble in hydrogen fluoride and water.

Though not intending to be bound by a particular theory, it is believed that hydrogen fluoride uptake by the copolymer is facilitated by the negatively charged carboxylic groups of the copolymer and their solvation with hydrogen fluoride molecules. For embodiments in which the copolymer includes an alkali metal or ammonium ion (e.g., copolymers formed with an acrylic acid salt), it is believed that, in the presence of hydrogen fluoride, the alkali metal or ammonium disassociates from the carboxyl group creating two ions: a carboxyl (COO−) and an alkali metal or ammonium ion (e.g., Na+). The carboxyl groups begin to repel each other because they have the same negative charge. This repulsion unfolds or swells the polymer chain. The swelling action also allows more hydrogen fluoride to associate with the polymer chain and reside in the spaces within the polymer's network. The ions are also likely to associate with the hydrogen fluoride. The hydrogen of the hydrogen fluoride or water interacts with negative carboxyl anions. Similarly, the fluoride of the hydrogen fluoride and oxygen of water interacts with the alkali metal or ammonium ion of the polymer. Furthermore, HF is also known to form complexes with amines and the nitrogen groups in the polymer may also facilitate uptake of HF by the polymer.

The cross-linking between polymer chains prevents the copolymer from dissolving in liquid hydrogen fluoride or other liquids. When the chains become solvated, the cross links prevent them from moving around randomly. In general, the cross-linking affects the copolymer's absorption capacity, with more cross links in a chain corresponding to a decrease in the polymer's ability to absorb liquids.

In some exemplary embodiments, the cross-linked copolymers of the present disclosure are constructed of both acrylamide units and acrylate units. Within the scope of the term “acrylamide”, included is acrylamide itself (i.e., 2-propenamide), polyacrylamides, polyalkylacrylamides (e.g., polymethylacrylamide), monomer residues of such acrylamides, and derivatives thereof. As used herein, the term “derivative” means a compound or chemical structure having the same fundamental structure or underlying chemical basis as the relevant related compound. Such a derivate is not limited to a compound or chemical structure produced or obtained from the relevant related compound. Acrylamide units that can be utilized in the present disclosure include individual structural units of acrylamide, repeating units of acrylamide, and polymer chains constructed, at least in part, of acrylamides.

Within the scope of the term “acrylate”, included is acrylic acid (i.e., 2-propenoic acid), acrylic acid salt (e.g., sodium acrylate, potassium acrylate, and the like), alkylacrylates (e.g. methyl acrylate, butyl methylacrylate, and the like), polyacrylates, polyalkylacrylates, polyacrylic salts, monomer residues of such acrylates, and derivatives thereof. Acrylate units that can be utilized in the present disclosure include individual structural units of acrylates, repeating units of acrylates, and polymer chains constructed, at least in part, of acrylates.

Exemplary acrylic acid salts include potassium acrylate, sodium acrylate, and ammonium acrylate. In some exemplary embodiments, the acrylic acid salt is potassium.

Polyacrylate-polyacrylamide cross-linked copolymers are commercially available from a variety of sources including Degussa AG of Krefeld, Germany (sold under the trade name STOCKOSORB®), Kyoritsu Yukikogyo Kenkyusho of Japan (sold under the trade name Hymosab® 200), and Aldrich of Milwaukee, Wis. (Cat. No. 43, 277-6.)

In some exemplary embodiments, copolymers of the present disclosure comprise as little as 1 wt. %, 5 wt. %, 10 wt. %, or 20 wt. %, or as great as 50 wt. %, 60 wt. %, 80 wt. %, or 99 wt. % of acrylamide units based upon the total weight of the copolymer, or within any range defined between any two of the foregoing values, such as 1 wt. % to 99 wt. % or 5 wt. % to 60 wt. %, for example.

In some exemplary embodiments, copolymers of the present disclosure comprise as little as 1 wt. %, 5 wt. %, 10 wt. %, or 20 wt. %, or as great as 50 wt. %, 60 wt. %, 80 wt. %, or 99 wt. % of acrylate units based upon the total weight of the copolymer, or within any range defined between any two of the foregoing values, such as 1 wt. % to 99 wt. % or 5 wt. % to 60 wt. %, for example.

In some exemplary embodiments, the cross-linked copolymers have a weight average molecular weight (Mw) as little as 5,000 Daltons, 10,000 Daltons, or 100,000 Daltons, or as great as 1,000,000 Daltons, 5,000,000 Daltons, or 10,000,000 Daltons, or within any range defined between any two of the foregoing values, such as from 5,000 Daltons to 10,000,000 Daltons or 5,000 Daltons to 5,000,000 Daltons, for example. Weight average molecular weight (Mw) may be determined by gel permeation chromatography (GPC), in which the polymer is dissolved and run with a carrier fluid through a column which separates the various molecular weight components which are then detected with an appropriate detector at the exit of the column.

To prepare the compositions of the disclosure, an effective amount of a cross-linked copolymer is mixed with hydrogen fluoride in any suitable corrosion resistant vessel to form an intimate mixture. An effective amount of cross-linked copolymer is an amount capable of decreasing the volatility and increasing the surface tension of the hydrogen fluoride to the level desired for the end use. Alternatively, hydrogen fluoride may be added to an amount of cross-linked copolymer capable of absorbing the amount of added hydrogen fluoride. Addition of the cross-linked copolymer and hydrogen fluoride may be performed in any sequence. Mixing may be accomplished by any means convenient, including without limitation, stirring or dispersing the copolymer into a pool of hydrogen fluoride or passing hydrogen fluoride gas over the cross-linked copolymer.

The aqueous hydrogen fluoride may be commercially available hydrogen fluoride having a water content as little as 0.06 wt. %, 0.15 wt. %, 0.5 wt. %, 0.6 wt. %, 1 wt. %, 2 wt. %, 3 wt. %, 5 wt. %, 10 wt. %, 12 wt. %, 25 wt. %, or 30 wt. %, or as great as 50 wt. %, 70 wt. %, 75 wt. %, 90 wt. %, 95 wt. %, 99 wt. %, 99.4 wt. %, 99.5 wt. %, or 99.9 wt. %, based on the total weight of water and hydrogen fluoride, or within any range defined between any two of the foregoing values, such as 0.06 wt. % to 99.9 wt. %, 0.06 wt. % to 90 wt. %, 50 wt. % to 99.9 wt. %, 0.06 wt. % to 30 wt. %, 1 wt. % to 30 wt. %, 2 wt. % to 30 wt. %, or 3 wt. % to 12 wt. %, for example.

The polymer may be in any form suitable for mixing with the hydrogen fluoride including, without limitation, granules, beads, pellets, fibers, or mats. Mixing will occur faster for smaller particle sizes of the polymer and slower for larger sizes. Typically mixing is performed at temperatures from about 0° C. to about 100° C., more particularly from about 10° C. to about 40° C., and even more particularly from about 10° C. to about 25° C. Pressure is not critical to the mixing operation, although capacity is generally lower at increased pressure.

The amount of hydrogen fluoride and cross-linked copolymer used will depend in part on the particular cross-linked copolymer selected and the desired end-use for the composition. If the cross-linked copolymer has a relatively low molecular weight, the resulting HF/cross-linked copolymer composition will be a viscous liquid. If the cross-linked copolymer has a relatively high molecular weight, the resulting composition will be a solid or semi-solid material (e.g., gel). Additionally, the amount of cross-linked copolymer used will determine whether or not the resulting composition is a solid or liquid. Generally, up to about 1 percent by weight, based on the total weight of the composition, of cross-linked copolymer is used the composition will be a viscous liquid. Compositions in which the amount of cross-linked copolymer is at least about 2 weight percent, generally, will take a gel-like semi-solid form.

It should be noted further that a higher weight percentage of cross-linked copolymer will lead to a greater the reduction in vapor pressure and an increase in surface tension. In certain embodiments, the reduction in surface tension will reduce hydrogen fluoride aerosolization. However, with an increase in weight percentage of cross-linked copolymer, the weight percentage of hydrogen fluoride in the composition decreases which may affect the composition's suitability for a desired end-use. Therefore, the effective amount of hydrogen fluoride and cross-linked copolymer used will depend on a consideration of a number of factors.

In some exemplary embodiments, the amount of cross-linked copolymer, based on the total weight of cross-linked copolymer and hydrogen fluoride, is as little as 0.5 wt. %, 1 wt. %, 2 wt. %, 5 wt. %, 10 wt. %, 25 wt. %, 40 wt. %, 45 wt. %, or 50 wt. %, or as great as 55 wt. %, 60 wt. %, 75 wt. %, 90 wt. %, 95 wt. %, 98 wt. %, 99 wt. %, 99.5 wt. %, or 99.9 wt. %, or within any range defined between any two of the foregoing values, such as from 0.5 wt. % to 99.9 wt. %, from 2 wt. % to 98 wt. %, from 25 wt. % to 75 wt. %, from 40 wt. % to 60 wt. %, or from 45 wt. % to 55 wt. %, for example.

The inventors have found that the cross-linked copolymers of the present disclosure have a lower capacity for aqueous hydrogen fluoride than either pure water or anhydrous hydrogen fluoride. It is possible to measure the capacity of a polymer for HF by mixing the polymer with an excess of HF, allowing the mixture to stand for a period of time such that the polymer becomes saturated, gravity or suction filtering off the excess HF, and weighing the saturated polymer as well as the excess HF.

It is contemplated therefore, that in addition to polyacrylate/polyacrylamide crossed-linked copolymers, other HF-absorbing polymers and copolymers may be practiced with the present disclosure. In some exemplary embodiments, these other polymers and copolymers are mixed with the polyacrylate/polyacrylamide crossed-linked copolymer to optimize several properties of the composition. Examples of other polymers that may be mixed with a polyacrylate/polyacrylamide crossed-linked copolymer include those described in U.S. Pat. No. 6,177,058. Exemplary additional polymers include water soluble polymers selected from the group consisting of cellulose ethers, modified starches, starch derivatives, natural gum derivatives, polyacrylic acid salts, ethylene oxide polymer, methacrylic acid polymer, polyethyleneimine polymer, polyvinyl pyrrolidone polymer and mixtures thereof.

Without departing from the scope of the disclosure, it will be recognized that other components also may be included in the compositions of this disclosure. The specific nature of these components will depend on the desired end use of the compositions.

Hydrogen fluoride, water, or a mixture of hydrogen fluoride and water may be recovered from the composition of the disclosure by treating the composition so as to liberate vapors of hydrogen fluoride, water, or a mixture of hydrogen fluoride and water. One means of treating the compositions in order to liberate hydrogen fluoride vapor is by heating the composition at elevated temperatures resulting in the liberation of vapors of hydrogen fluoride, water, or a mixture of hydrogen fluoride and water. The vapor may then be condensed by any convenient means. Alternatively, the hydrogen fluoride, water, or a mixture of hydrogen fluoride and water may be liberated by decreasing the pressure over the composition or increasing both the pressure and temperature and then condensing the vapors. As yet another alternative, hydrogen fluoride value may be recovered from the compositions by use of the compositions in any of the wide variety of processes that use hydrogen fluoride, such as those involving a HF catalyst, fluorinating agent, chemical synthesis, etching processes, and cleaning processes.

In a further embodiment, the cross-linked copolymer may be previously pretreated with hydrogen fluoride by contacting the cross-linked copolymer with hydrogen fluoride to absorb at least a portion of the hydrogen fluoride with the cross-linked copolymer, and then recovering at least a portion of the absorbed hydrogen fluoride from the cross-linked copolymer. In some exemplary embodiment, pretreating the cross-linked copolymer provides a higher rate of subsequent hydrogen fluoride recovery. In some exemplary embodiments, contacting a HF/pretreated cross-linked copolymer composition with water results in recovery of at least 80 wt. %, 85 wt. %, 90 wt. %, 95 wt. %, 98 wt. %, or about 100 wt. % of the hydrogen fluoride in the HF/polymer composition, or within any range defined between any two of the foregoing values, such as 90 wt. % to 100 wt. %, 95 wt. % to 100 wt. %, or 98 wt. % to 100 wt. % for example.

The compositions of the disclosure provide a convenient and safe method for storing hydrogen fluoride. Because the compositions exhibit little or no volatilization of hydrogen fluoride, the hazards of storing the hydrogen fluoride are significantly reduced. Further, the hydrogen fluoride may be recovered from the stored composition by the means described herein. Additionally, the stored material may be safely transported. The compositions of the disclosure may be prepared and then placed in a storage container by any convenient means. Alternatively, the compositions may be prepared in the storage container. Suitable storage containers are those containers made of, or lined with, a hydrogen fluoride resistant material such as carbon steel, fluoropolymers, MONEL®, and the like. Storage of the compositions may be for any length of time provided that the compositions are not exposed to air or other chemicals. In some exemplary embodiments, storage is under ambient conditions.

The stored composition may be safely and efficiently transported to a destination. Transporting of the composition may employ any conventional means such as rail car or truck. Once delivered to the destination, the stored composition may be treated to recover the hydrogen fluoride from the composition for use.

### EXAMPLES

### Example 1—Pure Water

About 1 g of Stockosorb M polymer (acrylamide/potassium acrylate copolymer, cross-linked), was obtained from Degussa AG, of Krefeld, Germany, and placed into contact with 600 ml of deionized water. Its capacity for absorbing water was about 270 g H₂O/g polymer. Titration of the excess, unabsorbed water did not detect acidity.

### Example 2—Anhydrous HF

Approximately, 0.5 grams of Stockosorb M, was placed into a perfluoroalkoxy (PFA) vessel fitted with a screen above the polymer, and evacuated. The PFA vessel was then weighed, and cooled to about −78° C. About 29 grams of anhydrous HF were distilled onto the polymer. The PFA vessel was warmed to room temperature and weighed. After about two hours, the PFA vessel was inverted and the excess HF drained into a second, evacuated PFA vessel. The HF-polymer gel remained on the filter screen in the first PFA vessel. The vessel containing the polymer gel was again weighed and the polymer found to have absorbed about 41.3 grams of HF per gram of polymer. This shows the very high capacity of the polymer for anhydrous HF.

### Example 3—89.99 wt. % Aqueous HF

Approximately 1.26 g of Stockosorb M polymer was contacted with an excess of 89.99 weight % aqueous HF. At equilibrium it had a capacity of 24.44 gram aqueous HF per gram of polymer. The excess liquid was titrated with standard NaOH and the total acidity measured was 83.7 weight % indicating polymer absorbed HF and water in approximately the same proportion that HF and water were present in the original solution.

### Examples 4, 4A, and 4B—49 wt. % Aqueous HF

Approximately 1.06 g of Stockosorb M polymer was contacted with an excess of 49 weight % aqueous HF. At equilibrium it had a capacity of 11.91 grams aqueous HF per gram of polymer. The excess liquid was titrated with standard NaOH and the total acidity measured was 48.2 weight % indicating polymer absorbed HF and water in approximately the same proportion that HF and water were present in the original solution. The experiment was repeated in triplicate and the results are shown in Table 1.

### Examples 5-9—Various Concentrations of Aqueous HF

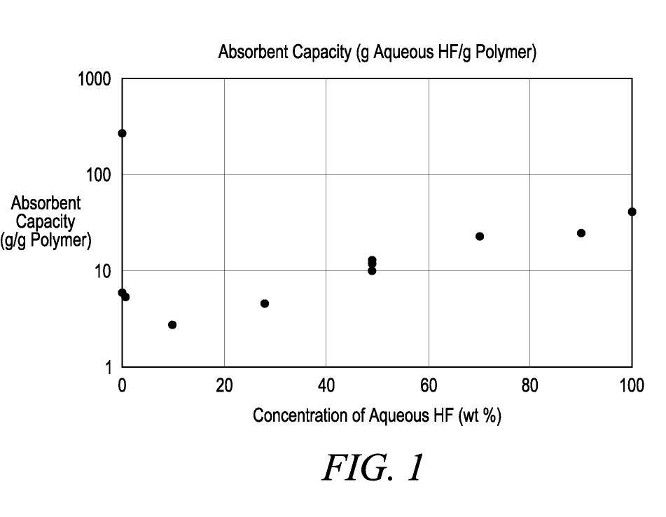

Example 3 was repeated with different starting concentrations of aqueous HF. The resulting Stockosorb M polymer capacities and the resulting solution total acidities are shown in Table 1. These results, along with Examples 1-4 are shown in FIG. 1. As shown in Table 1 and FIG. 1, the absorbent capacity of the cross-linked copolymer in aqueous hydrogen fluoride (Examples 3-9) was less than that in either pure water (Example 1—269.6 g/g polymer) or anhydrous hydrogen fluoride (Example 2—41.28 g/g polymer).

TABLE 1
Absorbent capacity as a function of HF concentration

| | Ex. 2 | Ex. 3 | Ex. 5 | Ex. 4 | Ex. 4A | Ex. 4B | Ex. 6 | Ex. 7 | Ex. 8 | Ex. 9 | Ex. 1 |
|---|---|---|---|---|---|---|---|---|---|---|---|
| Initial | 100 | 89.99 | 70.06 | 49 | 49 | 49 | 27.93 | 9.81 | 0.60 | 0.06 | 0 |
| wt. % HF | | | | | | | | | | | |
| Grams | 1 | 1.26 | 1.03 | 1.06 | 1.01 | 1.08 | 1.01 | 1.06 | 0.29 | 1.0 | 1.26 |
| starting | | | | | | | | | | | |
| polymer | | | | | | | | | | | |
| Grams | 42.28 | 32.06 | 24.41 | 13.68 | 14.09 | 11.83 | 5.69 | 3.99 | 1.83 | 6.97 | 340.96 |
| resulting gel | | | | | | | | | | | |
| Absorbent | 41.28 | 24.44 | 22.7 | 11.91 | 12.95 | 9.95 | 4.63 | 2.76 | 5.31 | 5.97 | 269.6 |
| capacity | | | | | | | | | | | |
| (g/g polymer) | | | | | | | | | | | |
| Un-absorbed | n/a | 83.70 | 68.79 | 48.16 | 47.92 | n/a | 27.57 | 9.56 | n/a | n/a | 0 |
| liquid total | | | | | | | | | | | |
| acidity (%) | | | | | | | | | | | |

### Example 10

After measuring the capacity in Example 4 (capacity=11.91 g 49 wt. % aqueous HF/g polymer) the saturated polymer was recovered for use in Example 10. 12.51 g of the saturated polymer was placed in 194.03 g of deionized water. After about 24 hours at room temperature the liquid was titrated and the total acidity determined to be 2.42 wt. % acid. If all the HF in the polymer had formed aqueous HF with the deionized water, the theoretical concentration of acid would have been 2.76 wt. % acid, or about 88% recovery of the HF in the polymer. Example 10 illustrated that most of the HF from the saturated polymer could be recovered as aqueous HF with very little being irreversibly bound to the polymer.

### Example 11

After measuring the capacity in Example 4A (capacity=12.95 g 49 wt % aqueous HF/g polymer) the saturated the saturated polymer was recovered for use in Example 10. 12.51 g of the composition was placed in 194.01 g of deionized water. After about 24 hours at room temperature the liquid was titrated and the total acidity determined to be 2.36 wt. % acid compared to a theoretical maximum of 2.71 wt. %, or about 88% recover of the HF in the polymer. We therefore observe that most of the HF could be recovered as aqueous HF with very little being irreversibly bound to the polymer.

### Example 12

Approximately 2 g of Stockosorb M was pretreated by saturating it with approximately 99 g of anhydrous HF, which was then removed by heating the gel to approximately 130° C. for a period of 3 hrs under vacuum. The recovered polymer was then divided into two approximately 1 g samples. The first sample was mixed with approximately 50 g of 49 wt. % aqueous HF, while the second sample was mixed with approximately 50 g of anhydrous HF. The samples were allowed to stand at room temperature overnight and their capacities were then determined to be approximately 3.6 g aqueous HF/g polymer and 19.4 g anhydrous HF/g polymer, respectively. The % total acidity of the residual solution obtained from the 49 wt. % aqueous HF sample was determined to be 48.5% acid. The gel prepared from the anhydrous HF was added to approximately 19.4 g of deionized water, allowed to stand overnight, and yielded an absorbent capacity of ca. 5.06 g/g and the resulting solution had a % total acidity of 51.5. %

### Example 13

Approximately 4.31 g of the gel prepared using 49 wt. % aqueous HF prepared in example 12 was mixed with approximately 50 g of deionized water to yield an approximately 3 wt. % aqueous HF solution.

A glass coupon was immersed in the resulting solution and the sample was allowed to stand at room temperature for a period of 2 hr. The coupon was inspected after 2 hr and was visibly etched and had lost approximately 3% of its initial weight.

While this invention has been described as relative to exemplary designs, the present invention may be further modified within the spirit and scope of this disclosure. Further, this application is intended to cover such departures from the present disclosure as come within known or customary practice in the art to which this invention pertains.

1. A composition comprising:
aqueous hydrogen fluoride; and
a cross-linked copolymer comprising acrylamide units cross-linked with an acrylic acid salt, wherein the cross-linked polymer has an average liquid aqueous hydrogen fluoride absorption capacity of less than 40 grams aqueous hydrogen fluoride per gram of cross-linked polymer.

2. The composition of claim 1, wherein the aqueous hydrogen fluoride comprises from 0.06 wt. % to 99.9 wt. % hydrogen fluoride, based on the total weight of hydrogen fluoride and water in the aqueous hydrogen fluoride.

3. The composition of claim 1, wherein the aqueous hydrogen fluoride comprises from 1 wt. % to 30 wt. % hydrogen fluoride, based on the total weight of hydrogen fluoride and water in the aqueous hydrogen fluoride.

4. The composition of claim 1, wherein the wherein the aqueous hydrogen fluoride comprises from 50 wt. % to 99.9 wt. % hydrogen fluoride, based on the total weight of hydrogen fluoride and water in the aqueous hydrogen fluoride.

5. The composition of claim 1, wherein the acrylamide units are polyacrylamide units.

6. The composition of claim 1, wherein the acrylate acid salt is selected from the group consisting of potassium acrylate, sodium acrylate, and ammonium acrylate.

7. The composition of claim 1, wherein the acrylate acid salt is potassium acrylate.

8. The composition of claim 1, wherein the cross-linked polymer is a cross-linked acrylamide/potassium acrylate copolymer.

9. The composition of claim 1, wherein the composition is in the form of a solid or a gel.

10. A method of forming an aqueous hydrogen fluoride composition, the method comprising mixing aqueous hydrogen fluoride and a cross-linked copolymer comprising acrylamide units cross-linked with an acrylic acid salt to form the aqueous hydrogen fluoride composition, wherein the cross-linked polymer has an average liquid aqueous hydrogen fluoride absorption capacity of less than 40 grams aqueous hydrogen fluoride per gram of cross-linked polymer.

11. The method of claim 10, wherein the composition is in the form of a solid or a gel.

12. The method of claim 10, wherein the aqueous hydrogen fluoride comprises from 0.06 wt. % to 99.9 wt. % hydrogen fluoride, based on the total weight of hydrogen fluoride and water in the aqueous hydrogen fluoride.

13. The method of claim 10, wherein the aqueous hydrogen fluoride comprises from 1 wt. % to 30 wt. % hydrogen fluoride, based on the total weight of hydrogen fluoride and water in the aqueous hydrogen fluoride.

14. The method of claim 11, wherein the acrylamide units are polyacrylamide units and the acrylate acid salt is selected from the group consisting of potassium acrylate, sodium acrylate, and ammonium acrylate.

15. The method of claim 11, further comprising contacting the aqueous hydrogen fluoride composition with water, thereby recovering in the water at least a portion of hydrogen fluoride from the aqueous hydrogen fluoride composition.

16. The method of claim 15, wherein the recovered hydrogen fluoride comprises at least 80 wt. % of the hydrogen fluoride in the aqueous hydrogen fluoride composition.

17. A method of recovering hydrogen fluoride from an aqueous hydrogen fluoride composition, the method comprising:
providing an aqueous hydrogen fluoride composition, the composition comprising hydrogen fluoride, water, and a cross-linked copolymer comprising acrylamide units cross-linked with an acrylic acid salt, wherein the cross-linked polymer has an average liquid aqueous hydrogen fluoride absorption capacity of less than 40 grams aqueous hydrogen fluoride per gram of cross-linked polymer; and
recovering at least a portion of the hydrogen fluoride, water, or hydrogen fluoride and water by vaporizing the water, hydrogen fluoride, or hydrogen fluoride and water from the aqueous hydrogen fluoride composition and condensing the water, hydrogen fluoride, or hydrogen fluoride and water.

18. The method of claim 17, further comprising:
pretreating the cross-linked copolymer with hydrogen fluoride by contacting the cross-linked copolymer with hydrogen fluoride to absorb at least a portion of the hydrogen fluoride with the cross-linked copolymer and recovering at least a portion of the absorbed hydrogen fluoride from the cross-linked copolymer; and
contacting pretreated cross-linked copolymer with aqueous hydrogen fluoride to form the aqueous hydrogen fluoride composition.

19. The method of claim 17, wherein the aqueous hydrogen fluoride comprises from 1 wt. % to 30 wt. % hydrogen fluoride, based on the total weight of hydrogen fluoride and water in the aqueous hydrogen fluoride.

20. The method of claim 17, wherein the acrylamide units are polyacrylamide units and the acrylate acid salt is selected from the group consisting of potassium acrylate, sodium acrylate, and ammonium acrylate.
